(19) United States
(12) Patent Application Publication
(10) Pub. No.: US 2018/0322538 A1
(43) Pub. Date: Nov. 8, 2018

(54) CONDITIONAL REMOVAL OF ADVERTISEMENTS FROM WEB CONTENT

(71) Applicant: OX Software GmbH, Monheim (DE)

(72) Inventors: Mikko Linnamäki, Stuttgart (DE); Peter Höbel, Bad Woerishofen (DE)

(21) Appl. No.: 15/585,485

(22) Filed: May 3, 2017

(51) Int. Cl. G06Q 30/02

(52) U.S. Cl. CPC G06Q 30/0277

(57) ABSTRACT

Some embodiments include a method to determine whether to remove third party content in web content requested by a user. The method includes receiving a request for web content from a client device associated with an IP address. The method also includes determining whether an ISP associated with the IP address is known. In response to determining that the ISP is known, a contract status of the IP address is determined and the web content is processed to manage third party content based on the contract status of the IP address. The method also includes transmitting the web content with additional processing to the client device at the IP address.

### FIELD

Some embodiments described herein generally relate to conditional removal of advertisements from web content.

### BACKGROUND

Unless otherwise indicated herein, the materials described herein are not prior art to the claims in the present application and are not admitted to be prior art by inclusion in this section.

Currently, a remote server adds advertisements to web content regardless whether a user wants the advertisements or not. For example, a remote server may add advertisements to web pages, chat rooms, instant messaging windows, and/or any other form of web content. Additionally, a remote server may add advertisements to web content displayed on different devices, such as desktop computers; mobile devices such as smartphones, tablet computers, laptop computers, personal digital assistants (PDAs), electronic reader devices, or other mobile devices; or other suitable client devices. There is no known option for the user to de-select advertisements put into the web content other than the use of an ad blocker. There is no known mechanism to deselect advertisements globally from web content by a user through providing extra information from an Internet service provider (ISP) associated with an Internet protocol (IP) address of the user to the remote server. Therefore, advertisements are always put into web content regardless of possible preferences of the user.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some embodiments described herein include methods to determine an ISP or a third party service as a representative for the ISP that is responsible for a user and to query trustworthy additional information about a contract status of the user. The ISP or third party service may be an external, central web service, provided by a third party (e.g., a clearing house) which may be responsible for one or more ISPs. The query may be done by a protocol that may guarantee that the remote server is connected to an expected ISP or third party service and the ISP or third party service can verify that the query is from an authorized remote server.

In an example embodiment, a method to determine whether to remove third party content (e.g., advertisements) in web content requested by a user includes receiving a request for web content from a client device associated with an IP address. The method also includes determining whether an ISP or third party service associated with the IP address is known. In response to determining that the ISP or third party service is known, a contract status of the IP address is determined and the web content is processed to manage third party content based on the contract status of the IP address. The method also includes transmitting the web content with additional processing to the client device at the IP address.

In another example embodiment, a method includes transmitting a secret key associated with a client identification to a remote server. The method may also include receiving a request for a contract status of an IP address from the remote server. The request for the contract status may include a client identification and a receive keyed-hash message authentication code (HMAC). The method may also include obtaining the contract status for the IP address from a web service end point associated with an ISP or third party service associated with the IP address. The method may also include generating a transmit HMAC based on the client identification and a secret key. The method may also include determining whether the receive HMAC and the transmit HMAC correspond. In response to determining that the receive HMAC and the transmit HMAC correspond, a status HMAC may be generated and a contract status message may be transmitted to the remote server. The status HMAC may be based on the contract status of the IP address and the contract status message may include the status HMAC.

Additional features and advantages of the disclosure will be set forth in the description which follows, and in part will be obvious from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth hereinafter.

### BRIEF DESCRIPTION OF THE DRAWINGS

To further clarify the above and other advantages and features of the present disclosure, a more particular description of the disclosure will be rendered by reference to specific embodiments thereof which are illustrated in the appended drawings. It is appreciated that these drawings depict only typical embodiments of the disclosure and are therefore not to be considered limiting of its scope. The disclosure will be described and explained with additional specificity and detail through the use of the accompanying drawings in which:

FIG. 1 is a flowchart of an example method for a remote server to receive and respond to a request for web content;

FIG. 2 is a flowchart of an example method to add third party content to web content by a remote server;

FIG. 3 is a flowchart of an example method to remove third party content from web content by a remote server;

FIG. 4 is a flowchart of an example method to verify validity of a request for a contract status;

FIG. 5 is a block diagram of an example operating environment for an ISP server/third party server and a remote server that may perform one or more of the methods of FIGS. 1, 2, 3, and/or 4; and

FIG. 6 is a block diagram illustrating an example computing device that is arranged to operate as a remote server and/or an ISP server/third party server,

all arranged in accordance with at least one embodiment described herein.

### DETAILED DESCRIPTION OF SOME EXAMPLE EMBODIMENTS

Some embodiments described herein generally relate to a system and method to conditionally remove third party content (e.g., advertisements) from web content. The described embodiments may add or permit third party content and/or remove or prohibit third party content from web content depending on a contract status of a web user (hereinafter “user”). In these and other embodiments, a communication protocol may be used to allow a remote server to query reliable information about the user's contract status from an ISP server or the third party service as a representative that is responsible for the user. The communication protocol may allow the ISP server or third party service server to reliably verify and authenticate the querying remote server. A third party service server may be an external, central web service, provided by a third party which may be responsible for one or more ISPs.

The ISP server or third party service server may provide a client-id, a secret key, and a cryptographic hash function, to compute a receive HMAC to the remote server. The receive HMAC may be used to authenticate the remote server and verify data sent by the remote server. Likewise, the ISP server or third party service may provide a web service end point to be used to query a user's contract status. The remote server may determine which ISP or third party service to request the contract status from by a look up in a predefined IP address list. The IP address list may include IP addresses, or IP address ranges of different ISPs.

In some embodiments, the contract status request to the web service end point may be sent using secure Hypertext transfer protocol (HTTPS) with certificate key pinning to increase security of the connection. Additionally or alternatively, the contract status request to the web service end point may be sent using HTTPS with domain name system (DNS)-based authentication of named entities (DANE) to increase security of the connection. In some embodiments, the secret key may be an RSA public key and the contract status request to the web service end point may be sent using an RSA encryption algorithm.

To determine the contract status of a user the remote server may create a client query JavaScript object notation (JSON) object including object members such as “client-id,” “hash,” “time,” and “ip”.

The following is an example client query JSON object, e.g., that may be sent by the remote server to the ISP:

{ “client-id” : “123245152”,
“hash” : “29d4a6a18b9b46ce957397a9f789543b”,
“time” : “2017-01-01T12:00:00”
“ip” : “10.1.2.10” }

The example client query JSON object includes four object members: “client-id”, “hash”, “time”, and “ip”. The object member “client-id” may include a string of characters that indicates a client identification, which the ISP server or third party service already may have provided to the remote server. The object member “time” may include a string of characters in ISO 8601 format or other suitable format and that indicates a current time at which the client query JSON object is being generated and sent. The object member “ip” may include a string of characters that indicates the IP address of the user. The object member “hash” may include a string of characters with a base64 encoded (or other suitable encoding) HMAC hash (e.g., the receive HMAC) of the concatenated values of the object members “ip” plus “time.”

In response to receiving the client query JSON object, the ISP server or third party service may transmit a response JSON object that includes one or more of the following object members: “hash,” “time,” “ttl,” “ip,” and “status”.

The following is an example response JSON object, e.g., that may be sent by the ISP or third party service to the remote server:

{ “hash” : “9b46ce95739729d4a6a18ba9f789543b”,
“ip” : “10.1.2.10”,
“time” : “2017-01-01T12:00:00”,
“ttl” : 3600,
“status” : true }

The object member “time” may include the string of characters in ISO 8601 format or other suitable format that indicates the time that the client query JSON object was generated and sent by the remote server. The object member “ttl” may include an integer which indicates a time to live in seconds for the information included in the response JSON object. The object member “ip” may include the string of characters that indicates the IP address of the user. The object member “status” may include a Boolean value which indicates whether advertisements shall be visible, or not. In some embodiments, the Boolean value may be a positive value (if true, advertisements are visible). Additionally or alternatively, the Boolean value may be a negative value (if true, advertisements are hidden). The object member “hash” may include a string of characters with a base64 encoded (or other suitable encoding) HMAC (e.g., the status HMAC) of the concatenated values of the object members “ip” plus “time” plus “ttl” plus “status.”

Reference will now be made to the drawings to describe various aspects of some example embodiments of the invention. The drawings are diagrammatic and schematic representations of such example embodiments, and are not limiting of the present invention, nor are they necessarily drawn to scale.

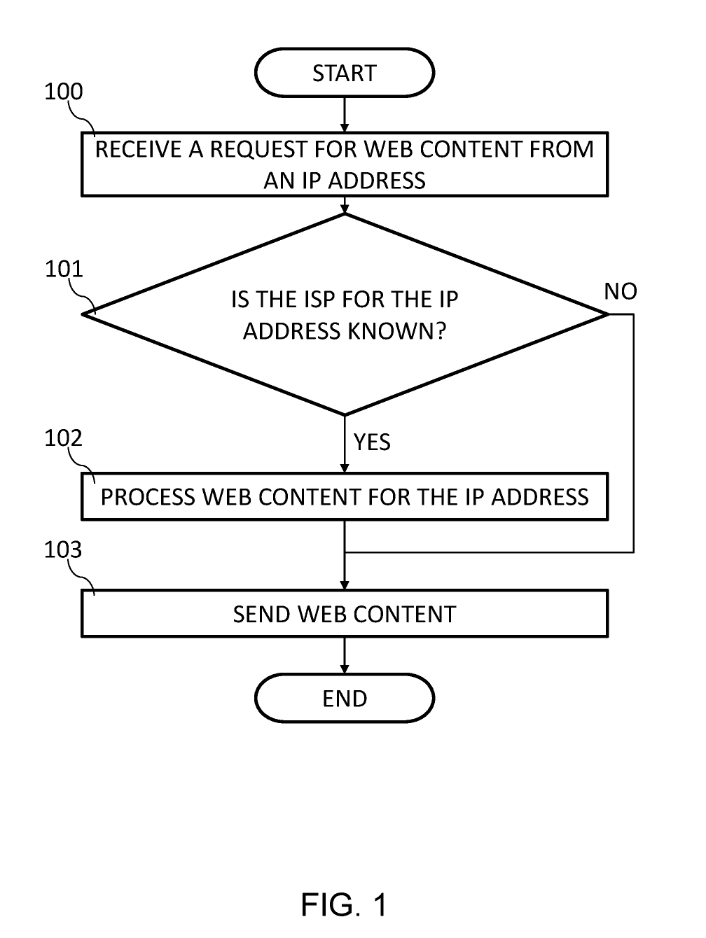

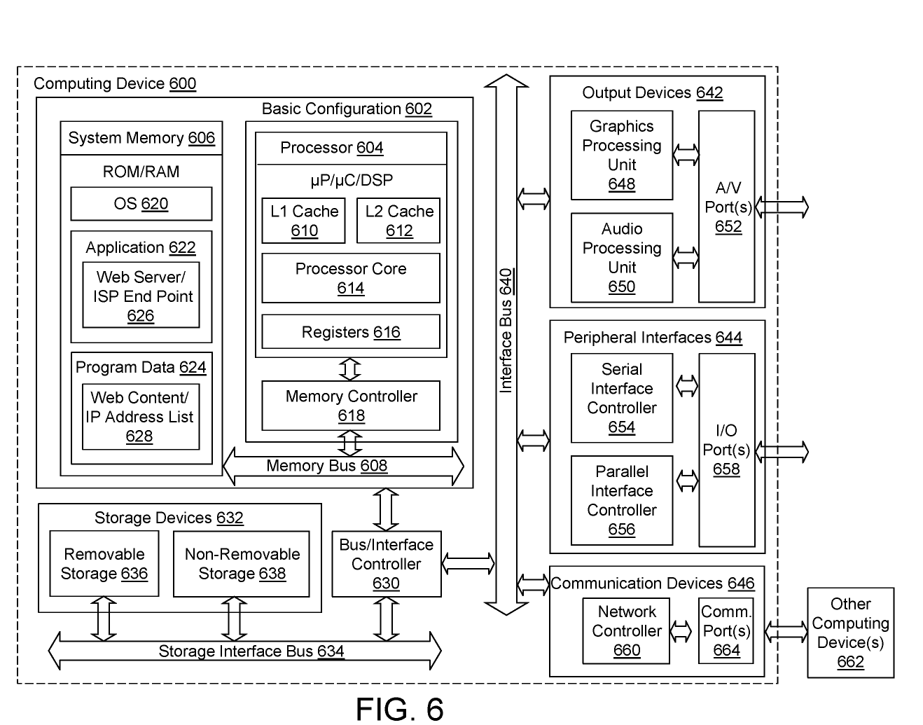

FIG. 1 is a flowchart of an example method for a remote server to receive and respond to a request for web content, arranged in accordance with at least one embodiment described herein. The method of FIG. 1 may be programmably performed or controlled by a processor in a remote server, such as one or more of the remote servers described herein. An example computing device that may include and/or correspond to the foregoing remote server and that includes one or more processors that may perform or control performance of the method of FIG. 1 is described below with respect to FIG. 6.

In general, the remote server may receive a request for web content from a client device associated with an IP address. The remote server may determine whether the ISP or third party service for the IP address is known. If the ISP or third party service for the IP address is not known, the remote server may send the web content to the client device without any additional processing. If the ISP or third party service for the IP address is known, the remote server may perform additional processing of the web content to manage third party content included in the web content based on a contract status of the IP address. The method of FIG. 1 may begin at block 100.

In block 100 [“RECEIVE A REQUEST FOR WEB CONTENT FROM AN IP ADDRESS”], the remote server receives the request for web content from a client device associated with an IP address and starts processing the request. Block 100 may be followed by block 101.

In block 101 [“IS THE ISP FOR THE IP ADDRESS KNOWN?”], the remote server determines if the ISP or third party service for the IP address is known. Additionally or alternatively, the remote server may determine a contract status of the IP address based on a contract status message received from an ISP server or third party service. Block 101 may be followed by block 102 (“YES” after block 101) or by block 103 (“NO” after block 101).

In block 102 [“PROCESS WEB CONTENT FOR THE IP ADDRESS”], the remote server processes the web content to manage third party content that may be included in the web content. Depending on the contract status of the IP address, the remote server may remove a portion of, remove all, or add additional third party content to the web content. For instance, the third party content may include advertisements for retailers. If the contract status of the IP address (or of the user or a user account associated with the IP address) indicates that the IP address is a member of a subscription group that prefers to have all advertisements removed from requested web content, the remote server may process the web content to not include any advertisements. In some embodiments, the contract status of the IP address may indicate that the user is a member of a subscription group that prefers to view advertisements only from particular groups. For example, the subscription group may prefer to view advertisements for particular retailers, retailer types, or product types. Additionally or alternatively, the contract status may indicate that the user is not a member of any subscription groups and the remote server may transmit the web content including all advertisements.

In block 103 [“SEND WEB CONTENT”], the web content is sent to the IP address. When the method of FIG. 1 includes processing of the web content at block 102, the web content that is sent to the IP address may be referred to as processed web content. The processed web content may include a portion of, all, or additional third party content (e.g., advertisements) according to the contract status of the IP address.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

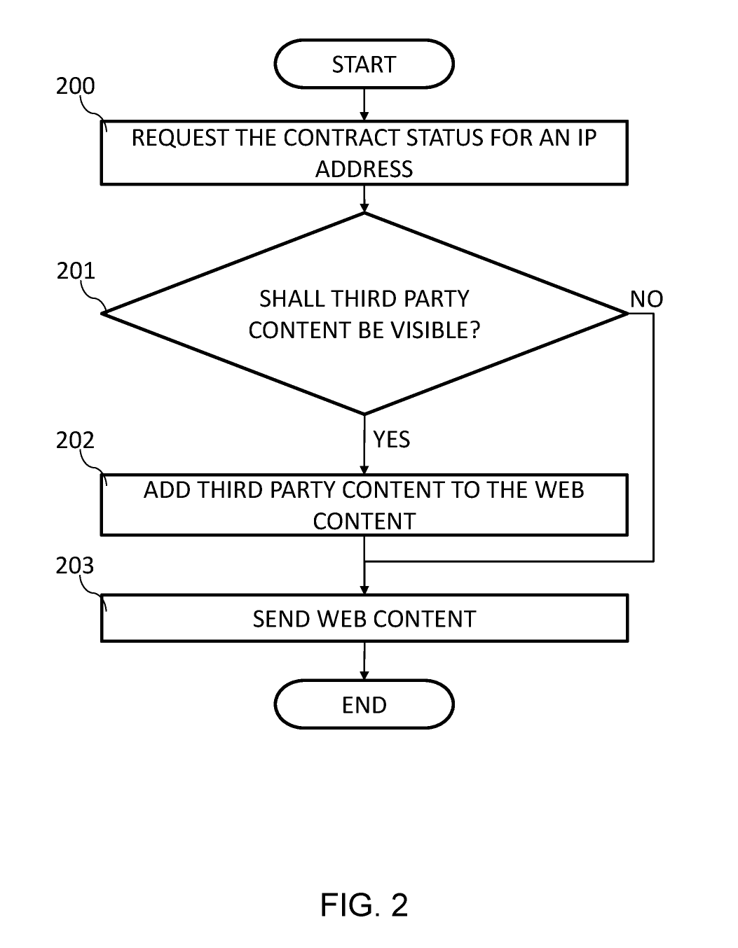

FIG. 2 is a flowchart of an example method to add third party content to web content by a remote server, arranged in accordance with at least one embodiment described herein. The method of FIG. 2 may be programmably performed or controlled by a processor in a remote server, such as one or more of the remote servers described herein. An example computing device that may include and/or correspond to the foregoing remote server and that includes one or more processors that may perform or control performance of the method of FIG. 2 is described below with respect to FIG. 6. The method of FIG. 2 may begin at block 200.

In block 200 [“REQUEST THE CONTRACT STATUS FOR AN IP ADDRESS”], the remote server requests the contract status from an ISP or third party service of an IP address associated with a client device that requested web content located on the remote server. In response to receiving the request for the contract status from the remote server, the ISP server or third party service transmits the contract status of the IP address to the remote server. Block 200 may be followed by block 201.

In block 201 [“SHALL THIRD PARTY CONTENT BE VISIBLE?”], the remote server determines if third party content, such as advertisements, shall be included (e.g., visible) on the web content based on the contract status of the IP address. Block 201 may be followed by block 202 (“YES” after block 201) or by block 203 (“NO” after block 201).

At block 202 [“ADD THIRD PARTY CONTENT TO THE WEB CONTENT”], the remote server adds the third party content to the web content.

At block 203 [“SEND WEB CONTENT”] the remote server sends the web content to the IP address.

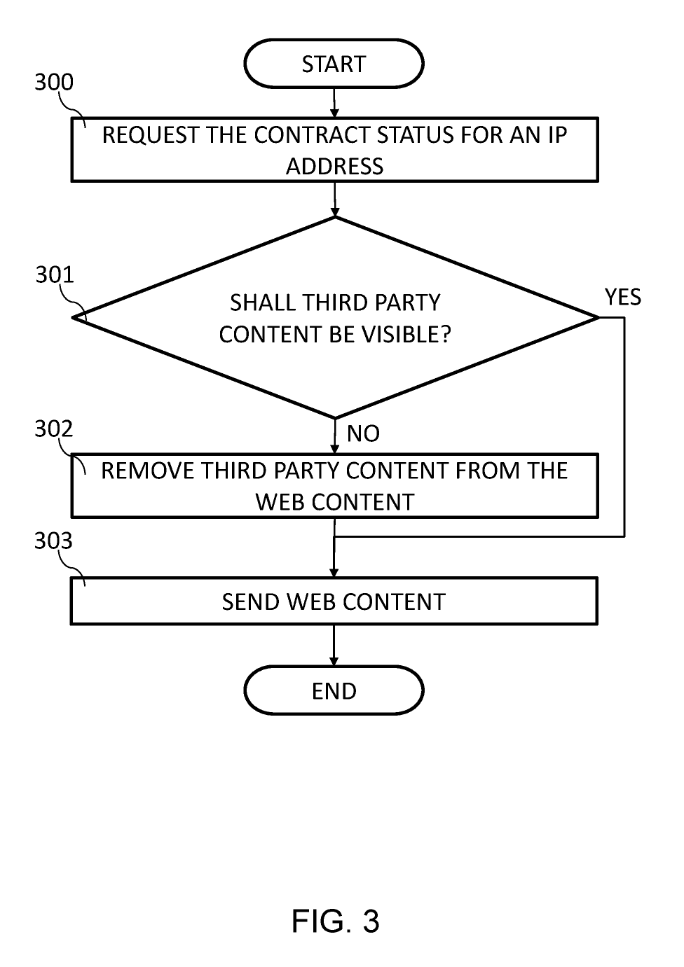

FIG. 3 is a flowchart of an example method to remove third party content from web content by a remote server, arranged in accordance with at least one embodiment described herein. The method of FIG. 3 may be programmably performed or controlled by a processor in a remote server, such as one or more of the remote servers described herein. An example computing device that may include and/or correspond to the foregoing remote server and that includes one or more processors that may perform or control performance of the method of FIG. 3 is described below with respect to FIG. 6. The method of FIG. 3 may begin at block 300.

In block 300 [“REQUEST THE CONTRACT STATUS FOR AN IP ADDRESS”], the remote server requests the contract status from an ISP or third party service of an IP address associated with a client device that requested web content located on the remote server. In response to receiving the request for the contract status from the remote server, the ISP server or third party service transmits the contract status of the IP address to the remote server. Block 300 may be followed by block 301.

In block 301 [“SHALL THIRD PARTY CONTENT BE VISIBLE?”], the remote server determines if third party content, such as advertisements, shall be included (e.g., visible) on the web content based on the contract status of the IP address. Block 301 may be followed by block 302 (“NO” after block 301) or by block 303 (“YES” after block 301).

At block 302 [“REMOVE THIRD PARTY CONTENT FROM THE WEB CONTENT”], the remote server removes the third party content from the web content. Block 302 may be followed by block 303.

At block 303 [“SEND WEB CONTENT”] the remote server sends the web content to the IP address.

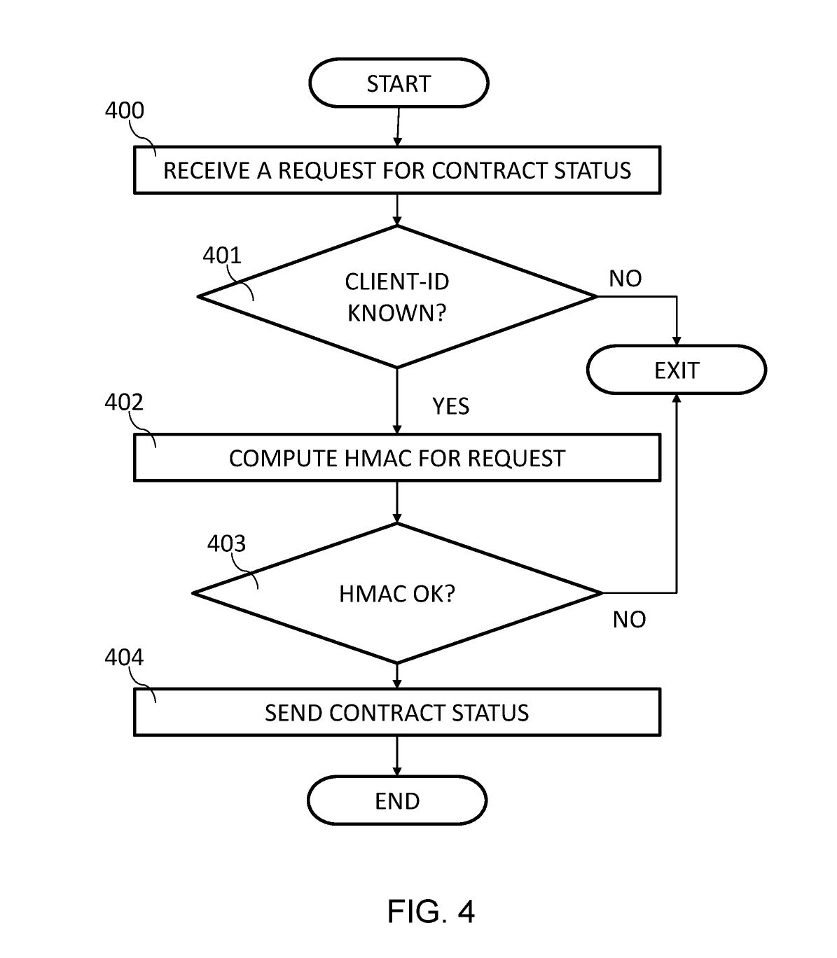

FIG. 4 is a flowchart of an example method to verify validity of a request for contract status, arranged in accordance with at least one embodiment described herein. The method of FIG. 4 may be programmably performed or controlled by a processor in an ISP server or third party service server. An example computing device that may correspond to the foregoing ISP server or third party service and that includes one or more processors that may perform or control performance of the method of FIG. 4 is described below with respect to FIG. 6. The method of FIG. 4 may begin at block 400.

In block 400 [“RECEIVE A REQUEST FOR CONTRACT STATUS”], the ISP server or third party service server receives a request, e.g., from a remote server, for contract status of an IP address associated with a client device that requested web content on the remote server. The request for contract status may include a receive HMAC based on a client identification and a secret key previously received from the ISP server or third party service server. In an example embodiment, the receive HMAC may be included in a client query JSON object and/or may include or correspond to a “hash” object member of the client query JSON object. In some embodiments, the request for contract status may be transmitted using an RSA encryption algorithm. In these embodiments, the request for contract status may include a receive RSA token based on the client identification and an RSA public key previously received from the ISP server or third party service server. The ISP server or third party service server may decrypt the receive RSA token using an RSA private key. The request for contract status may be transmitted using any suitable encryption algorithm. Block 400 may be followed by block 401.

In block 401 [“CLIENT ID KNOWN?”], the ISP server or third party service server determines if the client identification is known. For example, the client identification may be included in the request for contract status. Block 401 may be followed by block 402 (“YES” after block 401) or the method may end if the client identification is not known (“NO” after block 401). Alternatively or additionally, if the client identification is not known (“NO” after block 401), the ISP server or third party service server may return an error message to the remote server.

At block 402 [“COMPUTE HMAC FOR REQUEST”], the ISP server determines a transfer HMAC based on the client identification and the secret key. Block 402 may be followed by block 403.

At block 403 [“HMAC OK?”] the ISP server or third party service server determines if the receive HMAC and the transmit HMAC correspond. Block 403 may be followed by block 404 (“YES” after block 403) or the method may end if the receive HMAC and the transmit HMAC do not correspond (“NO” after block 403). Alternatively or additionally, if the receive HMAC and the transmit HMAC do not correspond (“NO” after block 403), the ISP server or third party service server may return an error message to the remote server.

At block 404 [“SEND CONTRACT STATUS”] the ISP server or third party service server may send a contract status message to the remote server. The contract status message may include a status HMAC based on the contract status of the IP address. The contract status message may indicate whether third party content is to be visible in the web content. The contract status message may include or correspond to a response JSON object, such as the example response JSON object discussed above. Accordingly, the status HMAC may be included in a response JSON object and/or may include or correspond to a “hash” object member of the response JSON object.

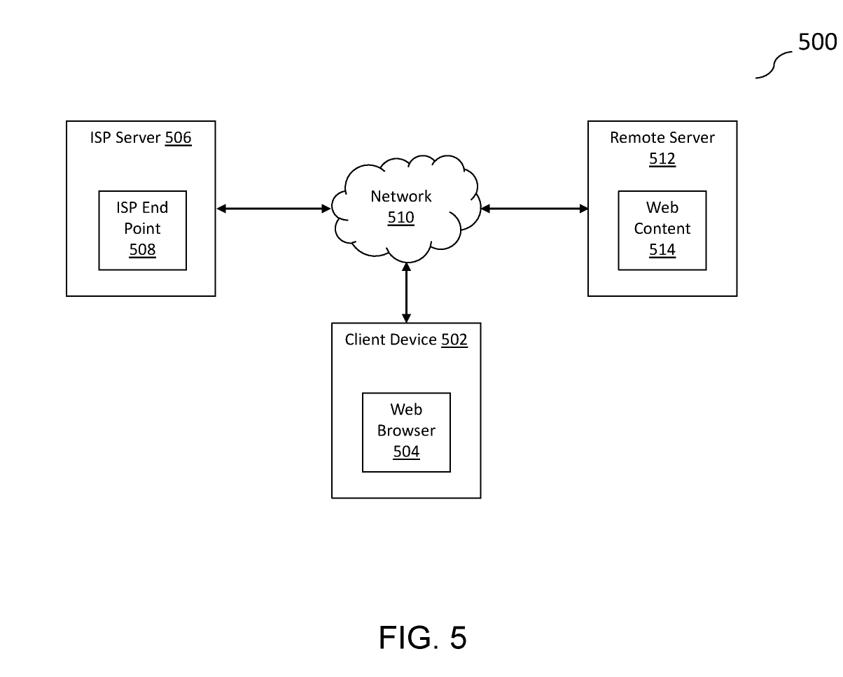

FIG. 5 is a block diagram of an example operating environment 500 for an ISP server/third party service 506 (hereinafter “ISP server”) and a remote server 512 that may perform one or more of the methods of FIGS. 1, 2, 3, and/or 4, arranged in accordance with at least one embodiment described herein. The operating environment 500 may include the ISP server 506, the remote server 512, a client device 502, and a network 510.

The ISP server 506 may include or correspond to the ISP server discussed above and elsewhere herein. The ISP server 506 may implement some or all of the communication protocol as described herein. For example, the ISP server 506 may perform the method of FIG. 4 and/or one or more other methods described herein. One example implementation of the ISP server 506 is described below with respect to FIG. 6. The ISP server 506 may include an ISP end point 508 (e.g., a web service end point). The ISP end point 508 may be used to communicate with external devices, such as the client device 502 and/or the remote server 512. The ISP end point 508 may be configured to securely communicate with external devices through HTTPS with certificate key pinning, HTTPS with DANE, RSA encryption, or any other secure protocol.

Additionally or alternatively, the ISP end point 508 may be used to determine the contract status of an IP address. The ISP end point 508 may be configured to look in a predefined IP address list to determine if a particular IP address is included in the IP address list. The predefined IP address list may be stored on one or more non-transitory computer-readable media. Non-transitory computer-readable media may include RAM, ROM, EEPROM, flash memory or other memory technology, CD-ROM, solid state storage devices, digital versatile disks (DVD) or other optical storage, magnetic cassettes, magnetic tape, magnetic disk storage or other magnetic storage devices, or any other non-transitory medium which may be used to store computer-readable instructions

The remote server 512 may include or correspond to the remote server discussed above and elsewhere herein. The remote server 512 may implement some or all of the communication protocol as described herein. For example, the remote server 512 may perform the method of FIGS. 1, 2, and/or 3 and/or one or more other methods or operations described herein. One example implementation of the remote server 512 is described below with respect to FIG. 6.

The remote server 512 may include web content 514 that is configured to be displayed on the client device 502. The web content 514 may include data corresponding to content associated with the web content 514. For example, the web content 514 may include a news web page such as cnn.com, bbc.com, nytimes.com, other news page, or other web page. Additionally or alternatively, the web content 514, may include chat rooms, instant messaging windows, or any other content that is accessible via the Internet. In some embodiments, the web content 514 may include third party content such as retailer advertisements. For example, the web content 514 may include advertisements for amazon.com, walmart.com, or other retailer(s). The third party content may be added to the web content 514 through any acceptable algorithm. For example, the algorithm may include an inline html algorithm, an iframe algorithm, a div algorithm, an image element algorithm, or any combination thereof. Additionally or alternatively, the web content 514 may include empty space that may be used for including third party content during processing.

The remote server 512 may be configured to transmit the web content 514 to the client device 502 in response to a request for web content. The remote server 512 may be configured to determine which ISP or third party service is associated with which IP's. For example, the remote server 512 may include IP data stored on one or more non-transitory computer-readable media. Non-transitory computer-readable media may include RAM, ROM, EEPROM, flash memory or other memory technology, CD-ROM, solid state storage devices, digital versatile disks (DVD) or other optical storage, magnetic cassettes, magnetic tape, magnetic disk storage or other magnetic storage devices, or any other non-transitory medium which may be used to store computer-readable instructions

The client device 502 may include a user device and/or may include a desktop computer; a mobile device such as a smartphone, a tablet computer, a laptop computer, a personal digital assistant (PDA), an electronic reader device, or other mobile device; or other suitable client device. The client device 502 may be associated with an IP address, which may be statically or dynamically set. The client device 502 may include a web browser 504 that is configured to request and display the web content 514. Examples of the web browser 504 may include Google Chrome, Internet Explorer, Safari, WhatsApp, Facebook, Google Hangouts, etc.

FIG. 5 illustrates a single client device 502. More generally, the operating environment 500 may include one or more client devices 502 for one or more users. In some embodiments, a single user may have multiple client devices 502, each with a different web browser 504, all of which can request and display the web content 514 or a single client device 502 with one or more web browsers 504 may be shared by multiple users.

The web browser 504 may be configured to request the web content 514 on the remote server 512 through the network 510. The request for the web content 514 may include the IP address associated with the client device 502.

The network 510 may communicatively couple the ISP server 506, the client device 502, and the remote server 512. The network 510 may include one or more wide area networks (WANs) and/or local area networks (LANs). In some embodiments, the network 510 may include the Internet, including a global internetwork formed by logical and physical connections between multiple WANs and/or LANs. Alternately or additionally, the network 510 may include one or more cellular RF networks and/or one or more wired and/or wireless networks such as, 802.xx networks, Bluetooth access points, wireless access points, IP-based networks, or the like. The network 510 may also include servers that enable one type of network to interface with another type of network.

The web browser 504 on the client device 502 may send a request for the web content 514 to the remote server 512. The request for the web content 514 may include the IP address associated with client device 502. The remote server 512 may determine which ISP is associated with the IP address. Additionally or alternatively, the request for the web content 514 may route through the ISP server 506 and may include a client identification of the user, a name of a cryptographic hash function for computing HMACs, and/or an ISP identification.

The remote server 512 may send a request for contract status to the ISP server 506. The request for contract status may be sent using HTTPS with DANE, HTTPS with certificate pinning, RSA encryption, or any suitable secure protocol. For example, the request for contract status may include a client query JSON object which may include object members such as the client identification, the current time, the receive HMAC, and the IP address associated with the client device 502. The receive HMAC may include a string of characters with a base64 encoded (or other suitable encoding) HMAC hash of the concatenated values of the current time and the IP address associated with the client device 502. The receive HMAC may be used to authenticate the remote server 512 and verify the other object members included in the JSON object. The receive HMAC may be based on a secret key previously received from the ISP server 506. The client identification may include a string of characters indicating the client associated with the web content request.

In another example, the request for contract status may include the client identification, the current time, a receive RSA token, and the IP address associated with the client device. The receive RSA token may be based on the client identification and an RSA public key. The request for contract status may be encrypted by the remote server 512 using the RSA public key previously received from the ISP server 506 (or third party service server).

The ISP end point 508 on the ISP server 506 (or third party service server) may receive the request for contract status and may look up the IP address in an IP address list. The ISP end point 508 may generate a transmit HMAC based on the secret key. The ISP end point 508 may determine whether the receive HMAC and the transmit HMAC correspond. If the receive HMAC and the transmit HMAC correspond, the ISP end point 508 may determine the contract status of the IP address. The ISP end point 508 may determine and/or generate a response JSON object that may include the current time, a TTL integer for the response JSON object, the IP address, a status HMAC, and a Boolean value indicating the contract status of the IP address. The status HMAC may include the concatenated values of the IP address, the current time, the ttl integer, and the contract status of the IP address. The Boolean value may indicate whether third party content shall be visible, or not. In some embodiments, the Boolean value may be a positive value (if true, advertisements are visible). Additionally or alternatively, the Boolean value may be a negative value (e.g., if true, advertisements are hidden). In embodiments in which the request for contract status was encrypted using an RSA encryption algorithm, the ISP end point 508 may decrypt the request for contract status using an RSA private key.

The ISP server 506 may transmit the response JSON object to the remote server 512. The remote server 512 may process the web content 514 based on the Boolean value included in the response JSON object. For example, the Boolean value may indicate that there is no contract with the IP address and may transmit the web content 514 to the web browser 504 on the client device 502 with all third party content (e.g., advertisements) visible. In another example, the Boolean value may indicate that the contract status of the IP address is to have no third party content visible on the web content 514 and may transmit the web content 514 with no third party content visible.

The ISP server 506 may track some or all of the web content requests transmitted by the web browser 504 on the client device 502. After a period of time, the ISP server 506 may determine how many web content requests were sent to the remote server 512 from the client device 502. The ISP server 506 may transmit this data to the remote server 512 to calculate a share of the user's subscription payments owed to a web host that maintains the web content 514.

FIG. 6 is a block diagram illustrating an example computing device 600 that is arranged to operate as a remote server and/or an ISP server/third party service server, arranged in accordance with at least one embodiment described herein. Accordingly, the computing device 600 may include or correspond to the ISP server 506 and/or the remote server 512 of FIG. 5. In a basic configuration 602, the computing device 600 typically includes one or more processors 604 and a system memory 606. A memory bus 608 may be used to communicate between the processor 604 and the system memory 606.

Depending on the desired configuration, the processor 604 may be of any type including a microprocessor (μP), a microcontroller (μC), a digital signal processor (DSP), or any combination thereof. The processor 604 may include one or more levels of caching, such as a level one cache 610 and a level two cache 612, a processor core 614, and registers 616. The processor core 614 may include an arithmetic logic unit (ALU), a floating point unit (FPU), a digital signal processing core (DSP Core), or any combination thereof. An example memory controller 618 may also be used with the processor 604, or in some implementations the memory controller 618 may include an internal part of the processor 604.

Depending on the desired configuration, the system memory 606 may be of any type including volatile memory (such as RAM), nonvolatile memory (such as ROM, flash memory, etc.), or any combination thereof. The system memory 606 may include an operating system 620, one or more applications 622, and program data 624. The application 622 may include a web server and/or ISP end point (“Web Server/ISP End Point” In FIG. 6) 626 that is arranged to receive requests for web content (in the case of a remote server) or requests for contract status (in the case of an ISP server/third party service server) and/or transmit contract status requests (in the case of an ISP server/third party service server) or web content (in the case of a remote server), as described herein. The program data 624 may include web content and/or an IP address list (“Web Content/IP Address List” in FIG. 6) 628 as is described herein. In some embodiments, the application 622 may be arranged to operate with the program data 624 on the operating system 620 such that one or more of the methods of FIGS. 1-4 and/or other methods or operations described herein may be implemented.

The computing device 600 may have additional features or functionality, and additional interfaces to facilitate communications between the basic configuration 602 and any involved devices and interfaces. For example, a bus/interface controller 630 may be used to facilitate communications between the basic configuration 602 and one or more data storage devices 632 via a storage interface bus 634. The data storage devices 632 may be removable storage devices 636, non-removable storage devices 638, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer-readable instructions, data structures, program modules, or other data.

The system memory 606, the removable storage devices 636, and the non-removable storage devices 638 are examples of computer storage media or non-transitory computer-readable media. Computer storage media or non-transitory computer-readable media includes RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other non-transitory medium which may be used to store the desired information and which may be accessed by the computing device 600. Any such computer storage media or non-transitory computer-readable media may be part of the computing device 600.

The computing device 600 may also include an interface bus 640 to facilitate communication from various interface devices (e.g., output devices 642, peripheral interfaces 644, and communication devices 646) to the basic configuration 602 via the bus/interface controller 630. The output devices 642 include a graphics processing unit 648 and an audio processing unit 650, which may be configured to communicate to various external devices such as a display or speakers via one or more A/V ports 652. The peripheral interfaces 644 include a serial interface controller 654 or a parallel interface controller 656, which may be configured to communicate with external devices such as input devices (e.g., keyboard, mouse, pen, voice input device, touch input device, etc.), sensors, or other peripheral devices (e.g., printer, scanner, etc.) via one or more I/O ports 658. The communication devices 646 include a network controller 660, which may be arranged to facilitate communications with one or more other computing devices 662 over a network communication link via one or more communication ports 664.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term “computer-readable media” as used herein may include both storage media and communication media.

The computing device 600 may be implemented as a portion of a small-form factor portable (or mobile) electronic device such as a smartphone, a personal data assistant (PDA) or an application-specific device. The computing device 600 may also be implemented as a personal computer including tablet computer, laptop computer, and/or non-laptop computer configurations, or a server computer including both rack-mounted server computer and blade server computer configurations.

In view of the foregoing, various embodiments that can be implemented independently or together will now be described. In an example embodiment, a method to determine whether to remove third party content (e.g., advertisements) from web content requested by a user, is described. The method includes receiving a request for web content from a client device associated with an IP address. The method also includes determining whether an ISP or third party service associated with the IP address is known. In response to determining that the ISP or third party service is known, a contract status of the IP address is determined and the web content is processed to manage third party content based on the contract status of the IP address. The method also includes transmitting the web content with additional processing to the client device at the IP address.

Alternatively or additionally, determining the contract status of the IP address may include requesting a contract status of the IP address from a web service end point that is associated with the ISP or third party service and receiving the contract status of the IP address from the web service end point.

Alternatively or additionally, requesting the contract status of the IP address from the web service end point associated with the ISP or third party service is performed according to HTTP with certificate pinning.

Alternatively or additionally, requesting the contract status of the IP address from the web service end point associated with the ISP or third party service is performed according to HTTP with DANE.

Alternatively or additionally, processing the web content to manage third party content may include removing all third party content from the web content prior to transmitting the web content to the client device.

Alternatively or additionally, processing the web content to manage third party content may include adding third party content to the web content prior to transmitting the web content to the client device.

Alternatively or additionally, processing the web content to manage third party content may include managing content associated with an iframe, a div, an image element, or an inline html algorithm.

In another example embodiment, a method includes transmitting a secret key associated with a client identification to a remote server. The method may also include receiving a request for a contract status of an IP address from the remote server. The request for the contract status may include the client identification and a receive HMAC. The method may also include obtaining the contract status for the IP address from a web service end point associated with an ISP or a third party service associated with the IP address. The method may also include generating a transmit HMAC based on the client identification and the secret key. The method may also include determining whether the receive HMAC and the transmit HMAC correspond. In response to determining that the receive HMAC and the transmit HMAC correspond, a status HMAC may be generated and a contract status message may be transmitted to the remote server. The status HMAC may be based on the contract status of the IP address and the contract status message may include the status HMAC.

Alternatively or additionally, the receive HMAC may include a string with a base64 encoded HMAC hash of concatenated values of the IP address and a current time.

Alternatively or additionally, the status HMAC may include a string with a base64 encoded HMAC hash of concatenated values of the IP address, a current time, a TTL integer for an answer, and a contract status value wherein the contract status value indicates whether third party content should be visible on web content requested by a client device at the IP address.

Alternatively or additionally, determining whether the receive HMAC and the transmit HMAC correspond may include determining whether the receive HMAC and the transmit HMAC are the same, e.g., match.

Alternatively or additionally, the request for contract status may include a JSON object including the client identification, the receive HMAC, a current time, and the IP address.

Alternatively or additionally, the contract status message may include a JSON object including the status HMAC, the IP address, a current time, a TTL integer for an answer, and a contract status value that may indicate whether third party content should be visible on web content requested by a client device at the IP address.

Alternatively or additionally, the contract status value may indicate that third party content should be removed from the requested web content.

Alternatively or additionally, the contract status value may indicate that third party content should be visible on the requested web content.

Embodiments described herein may be implemented using computer-readable media for carrying or having computer-executable instructions or data structures stored thereon. Such computer-readable media may be any available media that may be accessed by a general-purpose or special-purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable media.

Computer-executable instructions may include, for example, instructions and data which cause a general-purpose computer, special-purpose computer, or special-purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general-purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general-purpose hardware), specific hardware implementations or a combination of software and specific hardware implementations are also possible and contemplated. In this description, a “computing entity” may be any computing system as previously defined herein, or any module or combination of modulates running on a computing system.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
receiving a request for web content from a client device associated with an internet protocol (IP) address;
determining whether an Internet service provider (ISP) associated with the IP address is known;
in response to determining that the ISP is known, determining a contract status of the IP address, wherein the contract status indicates whether third party content is to be visible on the web content; and
processing the web content to manage the third party content based on the contract status of the IP address;
transmitting the web content with additional processing to the client device associated with the IP address; and
receiving a number of requests for web content from the client device associated with the IP address to determine a share of a subscription payment associated with the client device that is owed to a web host that maintains the web content.

2. The method of claim 1, wherein determining the contract status of the IP address comprises:
requesting the contract status of the IP address from a web service end point that is associated with the ISP; and
receiving the contract status of the IP address from the web service end point.

3. The method of claim 2, wherein requesting the contract status of the IP address from the web service end point associated with the ISP is performed according to Hypertext transfer protocol (HTTP) with certificate pinning.

4. The method of claim 2, wherein requesting the contract status of the IP address from the web service end point associated with the ISP is performed according to Hypertext transfer protocol (HTTP) with DNS-based authentication of named entities (DANE).

5. The method of claim 1, wherein processing the web content to manage the third party content comprises removing all third party content from the web content prior to transmitting the web content to the client device.

6. The method of claim 1, wherein processing the web content to manage the third party content comprises adding third party content to the web content prior to transmitting the web content to the client device.

7. The method of claim 1, further comprising, in response to determining that the ISP is unknown, transmitting the web content without processing the web content to manage third party content.

8. The method of claim 1, wherein processing the web content to manage the third party content comprises managing content associated with an iframe, a div, an image element, or an inline html algorithm.

9. A non-transitory computer-readable medium having computer-readable instructions stored thereon that are executable by a processing device to perform or control performance of the method of claim 1.

10. A method, comprising:
receiving a request for a contract status of an Internet protocol (IP) address from a remote server, wherein the request for the contract status includes a client identification and a receive keyed-hash message authentication code (HMAC);
obtaining the contract status for the IP address from a web service end point associated with an Internet service provider (ISP) associated with the IP address, wherein the contract status indicates whether third party content should be visible on web content requested by a client device associated with the IP address;
generating a transmit HMAC based on the client identification and a secret key associated with the client identification;
determining whether the receive HMAC and the transmit HMAC correspond;
in response to determining that the receive HMAC and the transmit HMAC correspond:
generating a status HMAC based on the contract status of the IP address; and
transmitting a contract status message to the remote server, the contract status message comprising the status HMAC;
tracking requests for web content from a client device associated with the IP address;
determining a number of requests for web content that were sent to the remote server from the client device; and
transmitting to the remote server the number of requests for web content that were sent to the remote server from the client device to determine a share of a subscription payment associated with the client device that is owed to a web host that maintains the web content.

11. The method of claim 10, wherein the receive HMAC comprises a string with a base64 encoded HMAC hash of concatenated values of the IP address and a current time.

12. The method of claim 10, wherein the status HMAC comprises a string with a base64 encoded HMAC hash of concatenated values of the IP address, a current time, a time to live (TTL) integer for an answer, and a contract status value wherein the contract status value indicates whether the third party content should be visible on the web content requested by the client device associated with the IP address.

13. The method of claim 10, wherein determining whether the receive HMAC and the transmit HMAC correspond comprises determining whether the receive HMAC and the transmit HMAC are the same.

14. The method of claim 10, wherein the request for contract status is a JavaScript Object Notation (JSON) object comprising the client identification, the receive HMAC, a current time, and the IP address.

15. The method of claim 10, wherein the contract status message is a JavaScript Object Notation (JSON) object comprising the status HMAC, the IP address, a current time, a time to live (TTL) integer for an answer, and a contract status value wherein the contract status value indicates whether the third party content should be visible on the web content requested by the client device associated with the IP address.

16. The method of claim 15, wherein the contract status value indicates that third party content should be removed from the requested web content.

17. The method of claim 15, wherein the contract status value indicates that third party content should be visible on the requested web content.

18. A non-transitory computer-readable medium having computer-readable instructions stored thereon that are executable by a processing device to perform or control performance of operations comprising:
receiving a request for a contract status of an Internet protocol (IP) address from a remote server, wherein the request for the contract status includes a client identification and a receive keyed-hash message authentication code (HMAC);
obtaining the contract status for the IP address from a web service end point associated with an Internet service protocol (ISP) associated with the IP address, wherein the contract status indicates whether third party content should be visible on web content requested by a client device associated with the IP address;
generating a transmit HMAC based on the client identification and a secret key associated with the client identification;
determining whether the receive HMAC and the transmit HMAC correspond;
in response to determining that the receive HMAC and the transmit HMAC correspond:
generating a status HMAC based on the contract status of the IP address; and
transmitting a contract status message to the remote server, the contract status message comprising the status HMAC;
tracking requests for web content from a client device associated with the IP address;
determining a number of requests for web content that were sent to the remote server from the client device; and
transmitting to the remote server the number of requests for web content that were sent to the remote server from the client device to determine a share of a subscription payment associated with the client device that is owed to a web host that maintains the web content.

19. The non-transitory computer-readable medium of claim 18, wherein determining whether the receive HMAC and the transmit HMAC correspond comprises determining whether the receive HMAC and the transmit HMAC are the same.

20. The non-transitory computer-readable medium of claim 18, wherein the contract status message indicates that third party content should be removed from web content requested by a client device associated with the IP address.
